(19) United States
(12) Patent Application Publication
(10) Pub. No.: US 2009/0243516 A1
(43) Pub. Date: Oct. 1, 2009

(54) LIGHT EMITTING APPARATUS

(76) Inventors: Wei-Shan Chiang, Tai-Chung City (TW); Chen-Hsien Han, Hsinchu City (TW); Meng-Yong Lin, Hsinchu City (TW); Ming-Huang Liu, Taipei Hsien (TW); Wei-Yang Ou, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 12/411,318

(22) Filed: Mar. 25, 2009

(30) Foreign Application Priority Data
Mar. 25, 2008 (TW) 097110562

(51) Int. Cl. H05B 37/02

(52) U.S. Cl. 315/307

(57) ABSTRACT

A light emitting apparatus includes a clock generating circuit and a light-emitting module. The clock generating circuit is for generating a clock control signal. The light emitting module includes a current supplying unit and a light emitting unit. The current supplying unit is for controlling a driving current flowing through a path, and includes a driving current source and a switch unit, which are both positioned in the path. The driving current source is for providing the driving current. The switch unit is coupled to the driving current source and the clock generating circuit, and refers to the clock control signal to open or short for controlling whether the driving current flows through the path. The light emitting unit is positioned in the path and coupled to the current supplying unit, and is for providing a light source according to the driving current.

### BACKGROUND OF THE INVENTION

1. Field of the Invention

The present invention relates to a light emitting apparatus, and more particularly, to a light emitting apparatus having a switch unit switching according to the clock control signal to control a driving current inputted into a light emitting unit.

2. Description of the Prior Art

When a liquid crystal display (LCD) displays a sequence of images such as a movie or animation, an object moving on a static background will look blurred or smeared along its edge. This effect is called motion blur, which is produced by the delay of the response time and the visual insistence of the human eye due to a hold-type LCD.

Since the principle of the response time of the liquid crystal and the hold-type LCD should be well known by those skilled in the art, further description is omitted here for brevity. To improve the motion blur, a method called overdrive (OD) is the method most often adopted to improve the delay of the response time. This method works by applying a driving voltage greater than a target voltage to the liquid crystals in order to accelerate the transition of liquid crystals and recover the driving voltage back to the target voltage, so that the response time of liquid crystals is reduced. To improve the motion blur due to a hold-type LCD, the simplest method is to insert a black frame between two normal frames. This driving method results in heavier loading of a central processing unit (CPU), however. Additionally, the data bus is an apparatus with higher power consumption, so using this driving method will consume more power.

### SUMMARY OF THE INVENTION

It is therefore one of the objectives of the present invention to provide a light emitting apparatus utilizing a switch unit to control a light emitting module to emit non-continuously for increasing the quality of the dynamic images, in order to solve the above-mentioned problem.

According to an exemplary embodiment of the present invention, a light emitting apparatus is disclosed. The light emitting apparatus comprises: a clock generating circuit, which is used for generating at least a clock control signal; and at least a light emitting module. The light emitting module has a current supply unit, which is used for controlling a driving current in a path; and a light emitting unit, which is positioned in the path and coupled to the current supply unit, and is used for providing a light source according to the driving current. The current supply unit has a driving current supply source, which is positioned in the path, and is used for supplying the driving current; and a switch unit, positioned in the path and coupled to the driving current source and the clock generating circuit, for switching according to the clock control signal to control whether the driving current flows through the path.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a light emitting apparatus according to an embodiment of the present invention.

FIG. 2 is a timing diagram of the clock control signal generated from the clock generating circuit shown in FIG. 1.

FIG. 3 is a diagram illustrating a light emitting apparatus according to another embodiment of the present invention.

FIG. 4 is a timing diagram of the plurality of clock control signals for the light emitting apparatus having a blanking back-light module.

FIG. 5 is a timing diagram of the plurality of clock control signals for the light emitting apparatus having a scanning back-light module.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

Different features of the present invention are detailed as below with reference to the figures, and for convenience of explanation, the same elements in different figures have the same reference numerals.

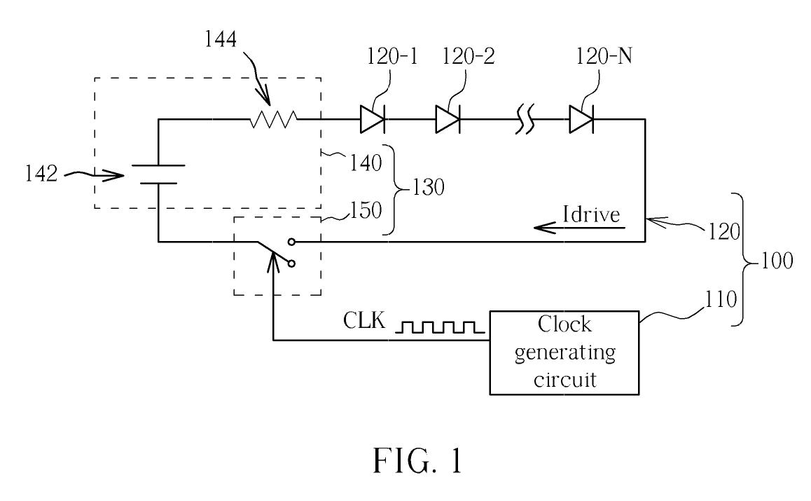

FIG. 1 is a diagram illustrating a light emitting apparatus 100 according to an embodiment of the present invention. As shown in FIG. 1, the light emitting apparatus 100 comprises a clock generating circuit 110 and a light emitting module 120. The light emitting module 120 has a plurality of light emitting units 120-1, 120-2, . . . , 120-N and a current supply unit 130. The current supply unit 130 has a driving current supply source 140 and a switch unit 150. The switch unit 150 is coupled to the driving current supply source 140 and the clock generating circuit 110. The clock generating circuit 110 is utilized for generating a clock control signal CLK. The current supply unit 130 is utilized for controlling a driving current Idrive in a path, and the light emitting units 120-1, 120-2, . . . , 120-N and the driving current supply source 140 and the switch unit 150 of the current supply unit 130 are all positioned in the path. The driving current supply source 140 is utilized for supplying the driving current Idrive. The switch unit 150 is utilized for switching according to clock control signal CLK to control whether the driving current Idrive flows through the path. The light emitting units 120-1, 120-2, . . . , 120-N is utilized for providing a light source according to the driving current Idrive.

In this embodiment, the light emitting units 120-1, 120-2, . . . , 120-N are implemented by light emitting diodes. Additionally, the light emitting apparatus 100 is disposed in a back light module of a mobile phone. This is, however, for illustrative purposes and should not be taken as a limitation of the present invention. For example, the light emitting apparatus of the present invention can be disposed in a back light module of any hand-held electronic apparatus, such as a hand-held game player. Please refer to FIG. 1 again. In the light emitting apparatus 100, the current supply source 140 has a voltage source 142 and resistance unit 144, and the resistance unit 144 is coupled to the voltage source 142 in series. In this embodiment, the resistance unit 144 is implemented by a resistor; this is, however, for illustrative purposes and should not be taken as a limitation of the present invention. In practice, the current supply source 140 can be any circuit having the capability to supply the driving current Idrive, such as a current source. Further description of the operation of the light emitting apparatus 100 is as follows.

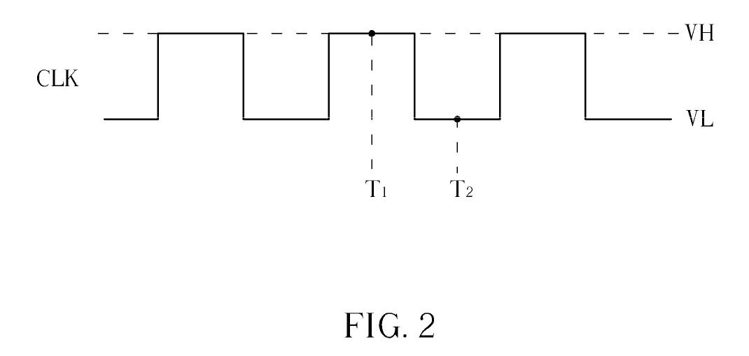

FIG. 2 is a timing diagram of the clock control signal CLK generated from the clock generating circuit 110 shown in FIG. 1. As shown in FIG. 2, the clock control signal CLK is a periodic square control signal; this is, however, for illustrative purposes and is not a limitation of the present invention. In this embodiment, when the clock control signal CLK is at a high voltage level VH (at time T1), the switch unit 150 is switched on to form a closed path between the light emitting units 120-1, 120-2, . . . , 120-N and the current supply source 140, so the driving current Idrive flows from the current supply source 140 through the light emitting units 120-1, 120-2, . . . , 120-N to the switch unit 150. In this manner, the light emitting units 120-1, 120-2, . . . , 120-N emit lights to provide the mobile phone with a light source. When the clock control signal CLK is at a low voltage level VL (at time T2), the switch unit 150 is switched off to form an open path between the light emitting units 120-1, 120-2, . . . , 120-N and the current supply source 140. In this manner, the light emitting units 120-1, 120-2, . . . , 120-N do not emit light. Therefore, a black frame can be inserted between two normal frames (i.e., the light emitting units do not emit light) at a suitable time to reduce motion blur without heavier loading for CPU and higher power consumption for the data bus if the clock generating circuit 110 generates the clock control signal CLK according to the dynamic images to be displayed on mobile phone screen.

Please note that, in the above embodiment, the switch unit 150 is disposed between the light emitting unit 120-N and the voltage source 142; this is, however, for illustrative purposes and should not be taken as a limitation of the present invention. In practice, the switch unit can be disposed anywhere in the path of the light emitting module 120. In addition, the switch unit can by any circuit component capable of switching between an on and off state, such as a mechanical switch or an electronic switch.

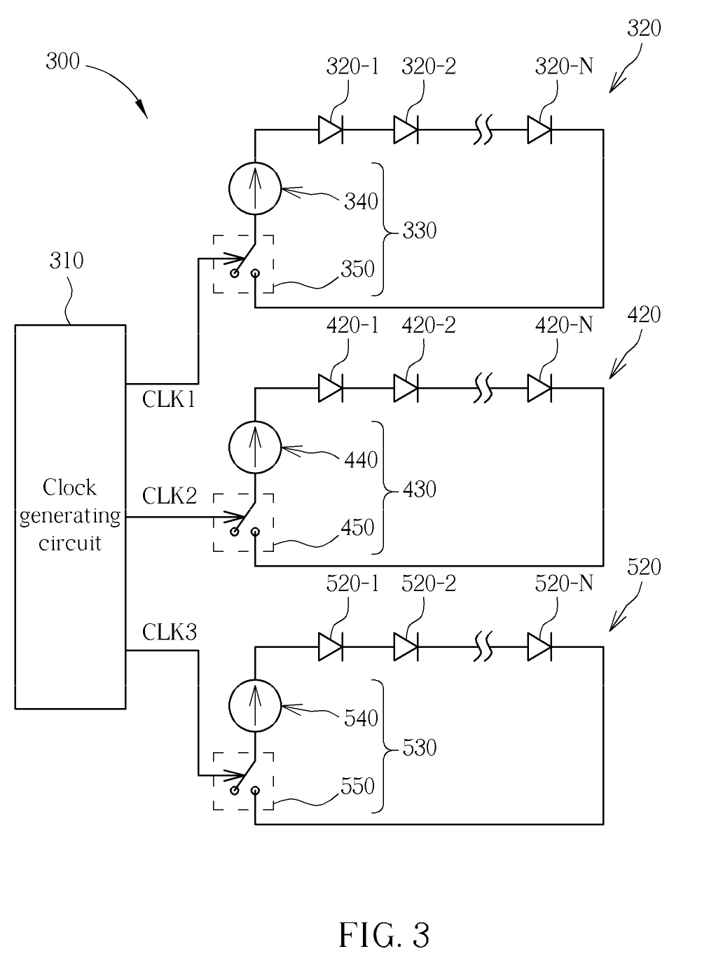

Furthermore, the light emitting module of the present invention can be applied to a conventional blanking back-light module or a conventional scanning back-light module without requiring a back light driver to control whether the back light source emits light, and the producing cost of the back light module can be significantly reduced accordingly. Please refer to FIG. 3. FIG. 3 is a diagram illustrating a light emitting apparatus 300 according to another embodiment of the present invention. As shown in FIG. 3, the light emitting apparatus 300 comprises a clock generating circuit 310 and a plurality of light emitting modules 320, 420 and 520. The light emitting modules 320, 420, 520 respectively have a plurality of light emitting units 320-1˜320-N, 420-1˜420-N, 520-1˜520-N and current supply units 330, 430, 530. The current supply units 330, 430, 530 respectively have driving current supply sources 340, 440, 540 and switch units 350, 450, 550. Differing from the driving current supply source 140 in the light emitting apparatus 100 shown in FIG. 1, the driving current supply sources 340, 440, 540 are all implemented by current sources. In addition, after reading the above-mentioned description concerning the light emitting modules 120, the corresponding operation of the light emitting modules 320, 420, 520 should be readily appreciated by those skilled in the art, so further description is omitted here for the sake of brevity. The clock generating circuit 310 is utilized for generating a plurality of clock control signals CLK1, CLK2, CLK3 and outputting them to the switch units 350, 450, 550 respectively, to control whether the 320-1˜320-N, 420-1˜420-N, 520-1˜520-N emit light.

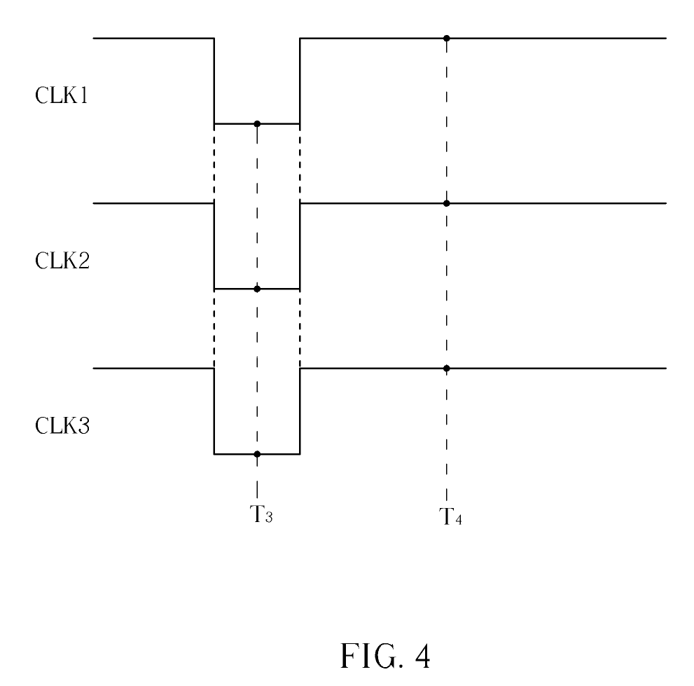

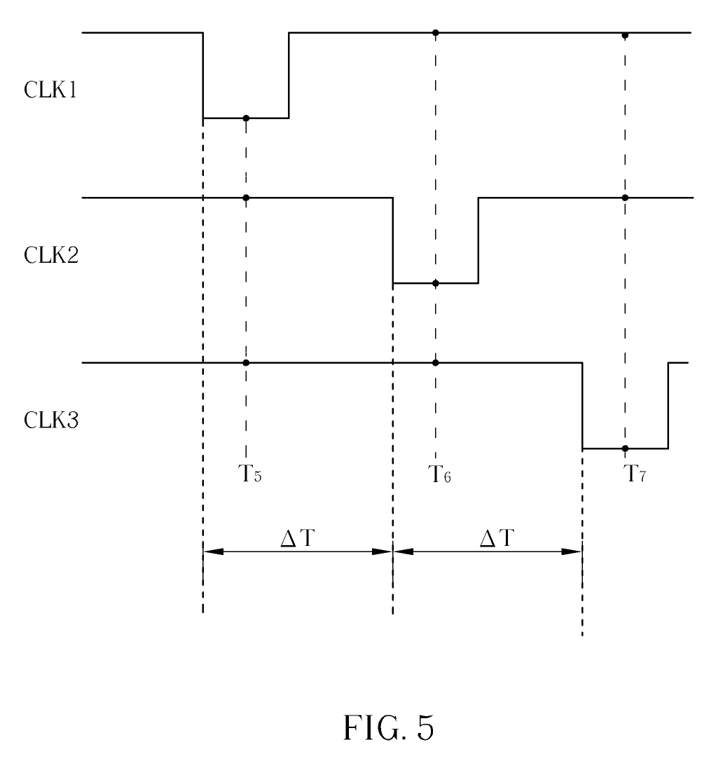

As regards the back light control for the blanking back-light module, please refer to FIG. 4. FIG. 4 is a timing diagram of the plurality of clock control signals for the light emitting apparatus 300 having a blanking back-light module. As shown in FIG. 4, there is no phase shift among the plurality of clock control signals. Therefore, when the plurality of clock control signals are all at a low voltage level (at time T3), all of the light emitting modules 320, 420, 520 are not lit. When the plurality of clock control signals are all at a high voltage level (at time T4), all of the light emitting modules 320, 420, 520 are lit. As regards the back light control for the scanning back-light module, please refer to FIG. 5. FIG. 5 is a timing diagram of the plurality of clock control signals for the light emitting apparatus 300 having a scanning back-light module. As shown in FIG. 5, there is a phase shift ΔT between the clock control signals CLK1 and CLK2, and there is also a phase shift ΔT between the clock control signals CLK2 and CLK3. Therefore, when the clock control signal CLK1 is at a low voltage level and the clock control signals CLK2 and CLK3 are at a high voltage level (at time T5), only the light emitting modules 420 and 520 are lit. Similarly, when the clock control signal CLK2 is at the low voltage level and the clock control signals CLK1 and CLK3 are at a high voltage level (at time T6), only the light emitting modules 320 and 520 are lit. When the clock control signal CLK3 is at the low voltage level and the clock control signals CLK1 and CLK2 are at a high voltage level (at time T7), only the light emitting modules 320 and 420 are lit. As seen from the above description, a back light control for the blanking or scanning back-light module is selected simply by appropriately adjusting the phase shifts among the clock control signals (i.e., appropriately controlling the phase shifts among the clock control signals).

Those skilled in the art will readily observe that numerous modifications and alterations of the device and method may be made while retaining the teachings of the invention.

What is claimed is:

1. A light emitting apparatus, comprising:
a clock generating circuit, for generating at least a clock control signal; and at least a light emitting module, having:
a current supply unit, for controlling a driving current in a path, having:
a driving current supply source, positioned in the path, for supplying the driving current; and
a switch unit, positioned in the path and coupled to the driving current source and the clock generating circuit, for switching according to the clock control signal to control whether the driving current flows through the path; and
a light emitting unit, positioned in the path and coupled to the current supply unit, for providing a light source according to the driving current.

2. The light emitting apparatus of claim 1, wherein when the switch unit switches on, the driving current flows from the light emitting unit to the switch unit; and the driving current supply source is a current source.

3. The light emitting apparatus of claim 1, wherein the driving current supply source comprises:
a voltage source; and
a resistance unit, coupled to the voltage source in series.

4. The light emitting apparatus of claim 1, being disposed in a back light module that has no back light driver.
